(19) United States
(12) Patent Application Publication
(10) Pub. No.: US 2002/0040756 A1
(43) Pub. Date: Apr. 11, 2002

(54) Apparatus for joining floor coverings

(76) Inventor: Christian Fitterer, Rheinstetten (DE)

Correspondence Address: Klaus J. Bach, 4407 Twin Oaks Drive, Murrysville, PA, 15668, US

(21) Appl. No.: 09/974,342

(22) Filed: Oct. 10, 2001

(30) Foreign Application Priority Data
Oct. 11, 2000 (DE) 100 50 139.7

(51) Int. Cl. B31F 5/00

(52) U.S. Cl. 156/157; 156/577

(57) ABSTRACT

In an apparatus for joining floor coverings by welding them together with a floor covering welding apparatus, the floor covering welding apparatus is mounted on a support structure on which also a floor covering seam cutter is supported at a predetermined distance from the welding apparatus so that the seam can be prepared for the following welding step and welded in a single procedure.

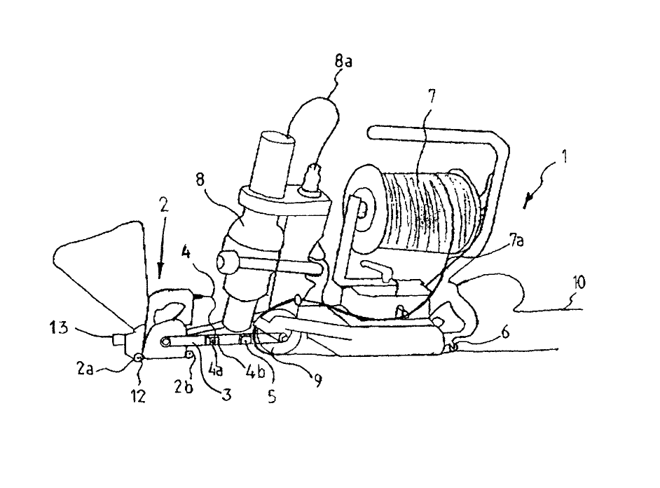

### BACKGROUND OF THE INVENTION

The invention relates to an apparatus for joining panels of floor coverings which panels are welded together along a pre-cut seam using a welding machine, which is moved along the seam.

It is known to weld PVC floor coverings, which consist of plates or courses, together at the seams. For this purpose, a welding apparatus is used including a movable frame which is provided with a drive and on which a reel of PVC welding rope is supported together with a burner. The PVC welding rope is placed, by a guide roller, into a seam that has been cut earlier.

The seam is always cut in a separate step before the welding. For cutting the seam, a so-called seam cutter is used. For cutting, the seam cutter is placed onto the floor and is moved along the joint between the two panels to be joined.

The seam cutter and the welding apparatus are different machines, which are used independently of each other and in different process steps. This is relatively expensive as two working procedures are performed along the same area at different times. Furthermore, wherever the joint between the panels of the floor covering is displaced the seam cutter must be moved on the floor covering in accordance with the displacement. To this end, the front part of the seam cutter must be moved sidewardly according to the amount of the displacement. When the sideward movement of the seam cutter is sufficiently large, the front part of the seam cutter is returned to its original position so that the seam cutter is moved over the floor along the displaced seam area.

It is therefore necessary to observe the floor carefully in order to detect any displacement of the seam. It is further necessary to manually direct the seam cutter to follow the seam and any displacement thereof.

It is the object of the present invention to provide an apparatus for joining floor covering panels or webs by which the joining procedure is facilitated.

### SUMMARY OF THE INVENTION

In an apparatus for joining floor coverings by welding them together with a floor covering welding apparatus, the floor covering welding apparatus is mounted on a support structure on which also a floor covering seam cutter is provided at a predetermined distance from the welding apparatus so that the seam can be prepared for the following welding step and welded in a single procedure.

With the apparatus according to the invention, the floor covering panels or webs can be welded together along a seam in the same procedure as the seam is cut while the seam cutter is moved along a seam together with the welding apparatus. The welding occurs at distance behind the cutting in a single procedure. The seam cutter and the welding apparatus are joined by a support structure, which maintains the seam cutter and the welding apparatus at a predetermined distance from each other. As a result, it is not necessary to first cut the seam in a first working procedure and then repeat the same movement for welding the seam in a second working procedure.

It is also possible to support the seam cutter and the welding apparatus in a sidewardly spaced relationship so that, when one seam is cut, a previously cut parallel seam is welded. However, with such an arrangement, the first seam must be cut in a separate step. The remaining seams are cut while, at the same time, another seam is welded.

Since, with the apparatus according to the invention, cutting and welding is performed in a single step, substantial savings in installation labor costs are achieved.

A substantial improvement is achieved if the front wheel of the seam cutter can be turned so as to make the cutter steerable. In this way, the seam cutter can be easily adapted to a displacement of the seam of the floor coverings to be welded. By a steering movement of the front wheel the seam cutter is capable of following the displacement of the seam.

With this embodiment, the apparatus according to the invention can be made operable by remote control. To this end, a remotely operated mechanism for turning the front wheel must be provided as it is provided for a particular embodiment of the invention.

It has been found to be particularly advantageous to provide the apparatus according to the invention with a camera, which observes the seam between two floor covering panels to be welded together. If the apparatus is provided with such a camera, an operator does not need to be in the immediate vicinity of the apparatus. The operator could be in a different room to avoid exposure to noise and dust.

In such an embodiment, it is advantageous if the camera is directed toward the seam immediately ahead of the front wheel of the seam cutter. In this way, the seam cutter and the whole apparatus can be precisely controlled.

It is also very advantageous if a drive is provided for remotely controlling the forward movement of the apparatus.

In this way, the speed of the seam welding apparatus can be adapted to the momentary conditions. The remote control can be connected to the apparatus by a cable. However, it is advantageous if the remote control is a radio signal control.

Preferably, the seam cutter is adjustable mounted to the support structure. Adjustability may be provided with respect to the vertical orientation of the seam cutter and also its horizontal orientation. With the adjustability of the seam cutter, the shape of the seam being cut is selectable. Furthermore, with such an adjustability of the seam cutter in the support structure, an error as it may occur by a not perfectly orientation of the support structure can be corrected.

It is advantageous for the operation of the seam cutter if the energy supply for the seam cutter is provided via the support structure. It is possible for example to provide the support structure with an electric receptacle by way of which electric current is supplied to the seam cutter. The power cord of the seam cutter may be only very short so that it is not bothersome during the cutting procedure.

It has been found to be also advantageous to arrange a switch in the area of the welding apparatus for switching the seam cutter on and off.

In this way, the seam cutter can be easily switched on and off by an operator. This arrangement is particularly advantageous if an error occurs or in case of a disturbance since the person operating the apparatus can easily and rapidly switch the cutter off whenever this should become necessary.

It is furthermore advantageous to provide a directional element for recording the direction in which the welding apparatus is moving. In this way, it can be assured in a simple manner, that the welding apparatus is moving over the floor in the proper direction. This is very important since, with a curved movement path of the seam cutter, the welding apparatus follows a wider curve radius in accordance with the distance between the seam cutter and the welding apparatus. For producing a straight seam, the welding apparatus must also follow a straight line.

Preferably, the support structure is designed to provide support for a commercially available welding apparatus and also a commercially available seam cutter. In this way, commercially available apparatus can be combined in a simple manner to provide an apparatus according to invention. Also, the apparatus can be provided rapidly and in a simple and inexpensive manner.

The invention will become more readily apparent from the following description of a particular embodiment thereof on the basis of the accompanying drawings.

### BRIEF DESCRIPTION OF THE DRAWINGS

The sole FIGURE shows the seam cutting and welding apparatus according to the invention.

### DESCRIPTION OF A PARTICULAR EMBODIMENT

As shown in the FIGURE, a welding apparatus 1 is provided with a support structure 3, on which, at the end remote from the welding apparatus 1, a seam cutter 2 is mounted. Energy is supplied to the seam cutter 2 by way of supply line 4, which includes a plug 4a, which is plugged into a receptacle 45 mounted to the support structure 3. The power supply to the receptacle 4b extends through the support structure 3. Immediately adjacent the welding apparatus 1, the support structure 3 includes a switch 5 by which the power supply to the receptacle 4b can be interrupted. Power to the switch 5 is provided by way of a switch for the on- and off-switching of the welding apparatus.

The seam cutter 2 is supported on the floor by way of a front wheel 2a and a rear wheel 2b. The front wheel 2a is rotatable about a first axis 12. The front wheel 2a is so connected to the seam cutter 2, that it can be pivoted about a second axis, which is not shown, for steering the seam cutter. The second axis extends about normal to the axis 12. The pivoting of the front wheel 2a about the second axis as well as the drive of the welding apparatus are controlled by a remote operating mechanism which is not shown in the drawings.

The support structure 3 may be provided in any appropriate form. However, it has to have sufficient rigidity to interconnect the seam cutter 2 firmly with the welding apparatus 1. The attachment depends on the construction of the welding apparatus. A specific connection of the support structure 3 to the welding apparatus 1 is not necessary for the realization of the inventive concept. The connection of the support structure 1 is performed by a skilled person so as to accommodate the design of the welding apparatus 1, for example, a bolted attachment or by welding.

As welding apparatus 1, a commercially available welding apparatus is preferably used. It includes essentially a storage reel 7 for a PVC welding string 7b. The PVC welding string is guided by a guide roller 9 and is pressed by the guide roller 9 into a groove cut by the seam cutter along the seam. A follower 6 in the form of a wheel is arranged in spaced relationship behind the drive wheel 9. The follower wheel 6 moves along the seam and provides for a straight-forward movement of the welding apparatus 1.

Immediately ahead of the guide roller 9, there is a burner 8, which is electrically heated. Electric energy is supplied to the burner 8 by way of the power supply cord 8a. For the electric power supply to the whole apparatus, that is the welding apparatus 1 and the seam cutter 2, a power supply line 10 is provided.

A camera 13 is provided and mounted so as to observe, and provide surveillance of, the seam immediately in front of the front wheel 12.

What is claimed is:

1. An apparatus for joining floor coverings comprising a floor covering welding apparatus with a forward drive for welding floor covering together along a seam between floor covering parts and a seam cutter for cutting a groove along the seam between the floor covering parts, and a support structure supporting said welding apparatus and said seam cutter at a predetermined distance from each other, said seam cutter including a front wheel rotatable about a first axis for supporting said seam cutter on said floor, said front wheel being pivotable controllably about a second axis for steering said seam cutter.

2. An apparatus according to claim 1, wherein the pivoting for steering said front wheel is achieved by remote control.

3. An apparatus according to claim 1, wherein a camera is provided for the surveillance of the seam between two floor covering parts to be joined.

4. An apparatus according to claim 3, wherein said camera is arranged so as to be directed toward the seam immediately in front of the front wheel of the seam cutter.

5. An apparatus according to claim 1, wherein the forward drive of said welding apparatus is remotely controlled.

6. An apparatus according to claim 1, wherein said seam cutter is adjustably supported on a support structure.

7. An apparatus according to claim 1, wherein means are provided on said support structure for supplying energy to said seam cutter.

8. An apparatus according to claim 1, wherein a switch is provided on said support structure near said welding apparatus for switching said seam cutter on and off.

9. An apparatus according to claim 1, wherein a follower element is mounted on said welding apparatus for ensuring straight forward movement of said welding apparatus.

10. An apparatus according to claim 1, wherein said support structure is adapted for supporting a commercially available welding apparatus and a commercially available seam cutter.
